(19) United States
(12) Patent Application Publication
(10) Pub. No.: US 2003/0044574 A1
(43) Pub. Date: Mar. 6, 2003

(54) Coil protector

(76) Inventor: Brian Jonathan O'Sullivan, Niagara Falls, NY (US)

Correspondence Address: Charles W Fallow, Shoemaker & Mattare, Suite 1203, 2001 Jefferson David Highway, Arlington, VA, 22202-0286, US

(21) Appl. No.: 10/148,194

(22) PCT Filed: Dec. 7, 2000
(86) PCT No.: PCT/CA00/01459

(30) Foreign Application Priority Data
Dec. 7, 1999 (CA) 2,291,899

(51) Int. Cl. B32B 3/10

(52) U.S. Cl. 428/131

(57) ABSTRACT

A shield is provided for the protection of the inner convolutions of a coil of sheet material, the coil having a central opening adapted to be engaged by a lifting device such as a probe inserted into the opening and then raised. The shield has a first section for insertion into an end of the central opening of the coil, the first section being part-cylindrical and shaped to span a substantial part of the periphery of the central opening. The shield further has a second section attached to the first section and extending outward to an outer edge, so that the second section abuts the end of a coil into which the first section has been inserted. At either peripheral end of the first section there is a wing section angled generally outwardly away from the axis of curvature of the first section so that, when the first section is positioned against the top of the central opening of a coil, the wing sections bear against the inside of the central opening and urge the first section upwardly, thus keeping it in place.

The present invention relates generally to coiled sheet material, and has to do in particular with protecting such sheet material from damage when coils are being lifted by devices such as a cantilevered probe or chains.

Prior Art

Large coils of sheet material are often transferred from one place to another by the use of cantilevered probes or posts which horizontally enter the open centre core of the coil, and then move upwardly so that the probe comes into contact with the internal convolutions of the coil, such that further upward movement will raise the coil off its previous support.

It is unavoidable that the curvature of the probe (when such is being used) has a smaller diameter than the curvature of the internal core of the coil, with the result that the lifting of a coil using a probe tends to distort the internal convolutions of the coil by bending them around the smaller curvature of the probe.

Coiled materials that are damaged in this way represent a substantial financial loss, since any permanent distortion at the opposed sides of the coil decreases the usable width of the coil, and requires additional labour in trimming the damaged edges. This causes unnecessary waste of material, and tends to increase the price of products fabricated from such coiled material, due to the waste factor.

This problem is particularly severe with expensive materials such as stainless steel or aluminum. Also, coils of relatively thin material such as gauge sheet steel tend to be particularly susceptible to edge damage during transportation.

The prior art includes my own earlier U.S. Pat. No. 5,861,274, dated Jan. 19, 1999, and directed to a “Roll Protection Shield and Method and Apparatus for Forming Same”. This earlier patent is directed to a shield useful for securely tying down coils of sheet material during transportation. It includes a first section for insertion into the bottom of an open end of a coil, the first section having a degree of curvature approximating that of the inside surface of the coil; and a second section integral with the first section and extending substantially perpendicular thereto, the second section abutting the end of the roll into which the first section is inserted. The previous patent also describes a method and apparatus for forming a coil-protector shield. Preferably, the shield is formed from ultra-high molecular weight polyethylene.

The shield of my earlier patent is not suitable for protecting the coil when being moved or transported by a probe or the like, because the shield has no means of holding itself at the top of the coil opening. In view of this, it will be clear that there is a need for some modality that will protect the vulnerable side edges of a coil of sheet material when it is being raised, moved or transported by the use of an internal probe.

### GENERAL DESCRIPTION OF THIS INVENTION

In view of the foregoing, it is an object of an aspect of this invention to provide a protective shield for use with coils of sheet metal or other material, particularly when such coils are being handled by the insertion of a cantilevered probe into the open centre core, followed by a lifting movement of the probe, with the effect of raising the coil from its support.

It is an object of a further aspect of this invention to provide a coil protector which is so shaped as to maintain itself in correct position at the top of the open core of a coil of sheet material, pending contact with a lifting probe.

More particularly, this invention provides, for use as a protector for the inner convolutions of a coil which has a central opening and which is to be lifted by a lifting device adapted to apply a lifting force against said inner convolutions, a shield comprising:

a first section for insertion into an end of said central opening, the first section being generally part-cylindrical and shaped to span a substantial part of the periphery of said central opening,

a second section attached to the first section and extending substantially outward therefrom to an outer edge, whereby the second section abuts the end of a coil into which the first section is inserted,

and, at either peripheral end of said first section, a wing section angled in a direction generally outwardly away from the axis of curvature of said first section, whereby, with the first section positioned against the top of said central opening, the wing sections bear against the inside of the central opening and urge the first section upward, thus keeping it in place.

### GENERAL DESCRIPTION OF THE DRAWINGS

One embodiment of this invention is illustrated in the accompanying drawings, in which like numerals denote like parts throughout the several views, and in which:

FIG. 1 is a plan view of a blank prior to forming into a coil protector;

FIG. 2 is a view of the coil protector after it has been formed but prior to being inserted into the open centre core of a coil of sheet material; and

FIG. 3 is a perspective view of the protector shown in FIG. 2, in which the broken lines represent one end of a coil into which the protector has been inserted.

### DETAILED DESCRIPTION OF THE DRAWINGS

Attention is first directed to FIG. 1, showing a plan view of a blank 10 which is preferably of ultra-high molecular weight high density polyethylene (UHMW) having a main body 12, two wing portions 14 and 16 at opposite ends of the main body 12, and six upstanding plate portions 18-23, which extend upwardly from the main body 12 and are separated by slots 25, each extending vertically and terminating in a rounded opening 28. The plate portions 18-23 are all substantially rectangular in configuration.

The forming process which transforms the blank 10 of FIG. 1 to the final condition illustrated in FIG. 3 involves firstly heating the blank 10 to an appropriate softening temperature. If ultra-high molecular weight (UHMW) polyethylene (such as Ramex®) is used for the blank, the heating of the blank would be sufficient to raise it to a temperature of 330±20° F. for 530±30 seconds. Then, the hot blank is transferred to a molding apparatus of the kind disclosed in my earlier U.S. Pat. No. 5,861,204. The transfer has to be accomplished quickly, so that the sheet remains relatively hot for the molding process.

The hot blank is then subjected to containment pressure within the mold for a period of time necessary to allow the surfaces of the sheet to cool down to about room temperature (45°-60° F.). This takes about 3 minutes.

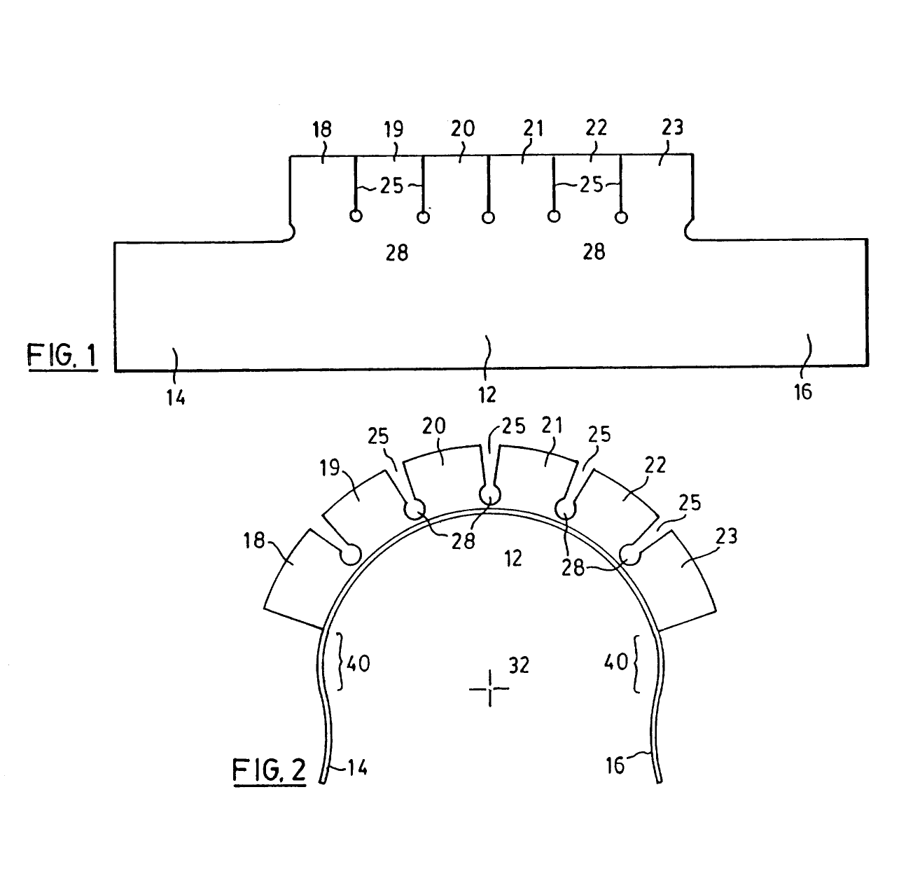

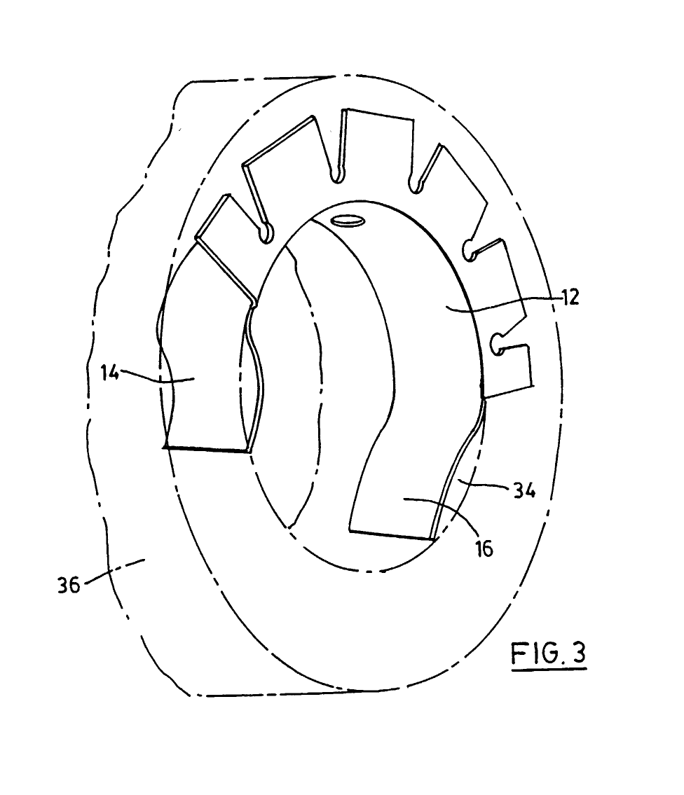

More specifically, the blank 10 is first caused to bend so that the main body takes a partial cylindrical shape, as seen edge-on in FIG. 2. During this part of the process, the plate portions 18-23 remain in alignment with the main body 12. The first part of the molding process also causes the wings 14,16 to assume a curvature such that they are generally angled in a direction outwardly away from the axis of curvature 32 of the main body 12 (see FIG. 2).

More specifically, the configuration of the wings 14 and 16 is such that, as seen in FIG. 3, when the first section (main body 12) is positioned against the top of a central opening 34 of a coil of sheet material 36, the wings 14 and 16 bear against the inside of the central opening 34 and urge the first section (main body 12) upward, thus keeping it in place.

Returning now to the process for forming the blank 10, the last step is to bend the plate portions 18,23 into a configuration where they lie in a common plane which is transverse to the cylindrical curvature of the main body 12 (and thus also to the axis represented by the centre of curvature 32 in FIG. 2). This is accomplished by the apparatus described and illustrated in my earlier U.S. Pat. No. 5,861,204, the contents of which are hereby incorporated by reference.

The result of this second step is a protective shield having the configuration illustrated in FIG. 2, adapted to be inserted into the open core of a coil shown in broken lines in FIG. 3, with the wings 14 and 16 bearing against the internal convolutions of the coil in such a way as to maintain the main body 12 pressing upwardly against the inside of the open core 34.

While the protective shield described above is preferably made of a single sheet or blank 10, it will be evident that it could also be constituted as several pieces which are heat-welded or otherwise attached together.

Attention is directed to FIG. 2, where it will be seen that there is a transition portion 40 between each wing section and the respective peripheral end 42 of the first section (main body 12). Each transitional portion 40 curves smoothly inwardly from the respective peripheral end 42, and then curves smoothly outwardly to merge with the respective wing section 14,16. As is clear, each transitional portion 40 spans a smaller peripheral extent of the central opening 34 then does the corresponding wing section 14,16.

While one embodiment of this invention has been illustrated in the accompanying drawings and described hereinabove, it will be evident to those skilled in the art that changes and modifications may be made thereto without departing from the essence of this invention, as set forth in the appended claims.

The embodiments of the invention in which an exclusive property or privilege is claimed are defined as follows:

1. For use as a protector for the inner convolutions of a coil which has a central opening and which is to be lifted by a lifting device adapted to apply a lifting force against said inner convolutions, a shield comprising:
a first section for insertion into an end of said central opening, the first section being generally part-cylindrical and shaped to span a substantial part of the periphery of said central opening,
a second section attached to the first section and extending substantially outward therefrom to an outer edge, whereby the second section abuts the end of a coil into which the first section is inserted,
and, at either peripheral end of said first section, a wing section angled in a direction generally outwardly away from the axis of curvature of said first section, whereby, with the first section positioned against the top of said central opening, the wing sections bear against the inside of the central opening and urge the first section upward, thus keeping it in place.

2. The shield claimed in claim 1, in which the first and second sections are integral with each other.

3. The shield claimed in claim 1 or claim 2, further including a transition portion between each wing section and the respective peripheral end of the first section, each transitional portion curving smoothly inwardly from said respective peripheral end and then curving smoothly outwardly to merge with the respective wing section, each transitional portion spanning a smaller peripheral extent of the central opening than does the corresponding wing section.

4. The shield claimed in claim 1, in which the shield is made by distorting a heated blank of thermoplastic material, and cooling the blank while maintaining the distorted configuration of the blank.

5. The shield claimed in claim 4, in which the second section exhibits a plurality of spaced-apart slots extending radially inward from said outer edge of the second section to terminate in a rounded aperture in the second section adjacent the first section, thereby to reduce stress concentration.
